(19) United States
(12) Patent Application Publication
(10) Pub. No.: US 2010/0153135 A1
(43) Pub. Date: Jun. 17, 2010

(54) SYSTEMS AND METHODS FOR MONITORING AND REWARDING PATIENT COMPLIANCE

(76) Inventor: Sung K. Park, Chestnut Hill, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/631,035

(22) Filed: Dec. 4, 2009

Related U.S. Application Data
(60) Provisional application No. 61/119,766, filed on Dec. 4, 2008.

(51) Int. Cl. G06Q 50/00; G06Q 99/00; B65D 85/00; B65D 83/04; A61J 1/03

(52) U.S. Cl. 705/3; 705/14.31; 206/459.5; 206/534; 206/531

(57) ABSTRACT

In embodiments of the present invention, a pharmaceutical product compliance reward method and system may include a pharmaceutical product, wherein the pharmaceutical product is marked with a unique identifier; a web site for entering the identifier when a user takes or otherwise utilizes the pharmaceutical product; and a reward system associated with the web site for identifying a condition for reward based on an identifier entered on the web site.

### CROSS-REFERENCE TO RELATED APPLICATIONS

This application claims the benefit of the following provisional applications, each of which is hereby incorporated by reference in its entirety:

U.S. Provisional Application No. 61/119,766, filed Dec. 4, 2008.

### BACKGROUND

This invention relates to systems and methods for improving medication adherence, also known as medication compliance.

A need exists for a method for monitoring and rewarding patient compliance and adherence to a prescribed course of medicine. This invention relates to rewarding patient compliance by tracking compliance with unique pharmaceutical identifiers.

### SUMMARY

In an aspect of the invention, a pharmaceutical product compliance reward method and system may include a web resource for entering a unique identifier from a pharmaceutical product or packaging when a user takes or otherwise utilizes the pharmaceutical product, and a reward facility associated with the web resource for identifying a condition for reward based on an identifier entered on the web site. In the method and system, the packaging may be at least one of a blister pack, a bottle, a carton, an ampoule, a syringe, a pill box, an inhaler, an inhaler cartridge, and a capsule. In the method and system, the reward value, the frequency of a reward being awarded, or both may be correlated with the user's medication compliance history. The compliance history may be for a specified period of time.

In one aspect, a system disclosed herein includes a web resource adapted to receive a user identification for a user and a unique identifier for a pharmaceutical product over a network from the user; and a reward facility associated with the web resource, the reward facility configured to identify a reward for the user based on the user identification, the unique identifier and an inference that the user has used the pharmaceutical product within a predetermined time of when the unique identifier is received by the web resource. The unique identifier may be obtained from packaging for the pharmaceutical product including at least one of a blister pack, a bottle, a carton, an ampoule, a syringe, a pill box, an inhaler, an inhaler cartridge, and a capsule. The unique identifier may be obtained from the pharmaceutical product. The reward may be determined based upon a plurality of unique identifiers comprising a treatment history for the user.

In an aspect of the invention, a system and method for improving medication adherence by a user may include identifying a medication user, obtaining the user's pharmaceutical product compliance history for a specific medication, determining whether a reward should be provided for a given compliance event as a function of the user's pharmaceutical product compliance history, if a reward is to be provided, determining a reward value, and providing the user with a reward report indicating whether a reward will be awarded and if so, the reward value. The method and system may further comprise calculating a pharmaceutical product compliance rate over a specific period of time based on the pharmaceutical product compliance history and determining whether a reward should be provided for a given compliance event as a function of the user's pharmaceutical product compliance rate. In the method and system, the reward value may be determined as a function of the user's pharmaceutical product compliance history. In the method and system, the reward value, the frequency of a reward being awarded, or both may be positively correlated with an improvement in the user's pharmaceutical product compliance history. In the method and system, the reward value, the frequency of the reward being awarded, or both may be inversely correlated with the user's pharmaceutical product compliance history. In the method and system, the reward value, the frequency of the reward being awarded, or both may be selected from among a plurality of predetermined values, and wherein each predetermined value is associated with a particular measure of pharmaceutical product compliance.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 is a flow chart for a pharmaceutical product compliance rewards system.

FIG. 2 is a flow chart of a method for improving medication adherence by a user.

FIG. 3 is a block diagram of a pharmaceutical product compliance reward system.

### DETAILED DESCRIPTION

In an embodiment, a method of monitoring and rewarding patient compliance with prescribing instructions may involve an online system for tracking unique identifiers on pharmaceutical, nutraceutical, supplements, and the like, or their packaging, hereinafter referred to as a pharmaceutical product. The pharmaceutical products may be dispensed in a dispenser. The dispenser may include pill bottles, disk-shaped inhalers, standard inhalers, eyedrop bottles, carton, bottle, and blister packs. The pharmaceutical product may include pills, tablets, capsules, lozenges, and the like.

In order to encourage compliance with prescribing information and recommended dosage information, a compliance monitoring and rewarding system may enable a user to enter the unique identifier from the pharmaceutical product into a rewards system. The user may input the prescribing instructions for the pharmaceutical product to the rewards system so that the rewards system may track compliance events and non-events that form, e.g., a history of treatment or a history of medication. In certain embodiments, the information for contacting the rewards system may be indicated on the pharmaceutical product or the dispenser.

In an embodiment, the unique identifier for the pharmaceutical product may be imprinted on the individual pharmaceutical unit or may be imprinted on the pharmaceutical dispenser or packaging using any suitable techniques to provide a visible product identifier that the user can read and enter into, e.g., the web resource described below. For example, for dispensers used by pharmacists, the dispensers may be provided to the pharmacists already marked with the unique identifier or the system may include a plug-in to enable the pharmacist to print a unique identifier on the label associated with the pharmaceutical product or dispenser. The packaging may be at least one of a blister pack, a bottle, a carton, an ampoule, a syringe, a pill box, an inhaler, an inhaler cartridge, and a capsule.

The unique identifier may encode information such as typical prescribing information, pharmaceutical formulation, dosage, and the like, or the unique identifier may be referenced in a database or the like to any relevant information for the pharmaceutical product. When the user takes the pharmaceutical product, they may use a computer, phone, wireless device or other input device to alert the rewards system that they are taking the pharmaceutical product and to enter the unique identifier located on the pharmaceutical product (or packaging). The system may update a medication compliance history for the user. The medication compliance history may be maintained by the rewards system or may be associated with an electronic health record, medication administration record, and the like. The history may include medication compliance events, or a lack of expected compliance events based on prescribing information as indicated by the unique identifier or the user. A compliance event may occur when a user inputs a valid unique identifier, that is, a unique identifier associated with the prescription being tracked for compliance, to a rewards system during an appropriate time period, such as one or more hours before or after a prescribed time to take a given pharmaceutical product. A predetermined time period for qualifying as a compliance event may be set by the rewards system, the identifier, the user, a medical professional, and the like. In this manner, the reward system may infer from a receipt of the unique identifier that the corresponding pharmaceutical was used by the user within the predetermined time period of receipt of the unique identifier, and use this as a basis for evaluating potential rewards. The user may be identified by any suitable user identification such as login credentials, an identification code, or the like, so that where appropriate, the dosing for the specific user based on age, height, weight, medical history, and so forth may be considered in identifying potential rewards. A pharmaceutical product compliance history may be maintained for each pharmaceutical product being taken by a user.

In an embodiment, medication compliance may be rewarded. Rewards may include cash, prizes, loyalty points, and the like for taking a pharmaceutical product as prescribed or indicated. The reward may be intermittent with a fixed or varying value or constant with a fixed or varying value. For example, the value could be a chance to obtain a larger reward, such as a lottery ticket. In another example, the value could be one dollar. In yet another example, the value could be one or more “points” or coupons, which may be combined with other points or coupons to obtain a larger reward, such as airline tickets, a vacation package, and the like. As another example, discounts on future medication, or one or more free doses, may also or instead be provided. In any event, monetary rewards or other credits may be added to an electronic or physical gift card for online or offline redemption.

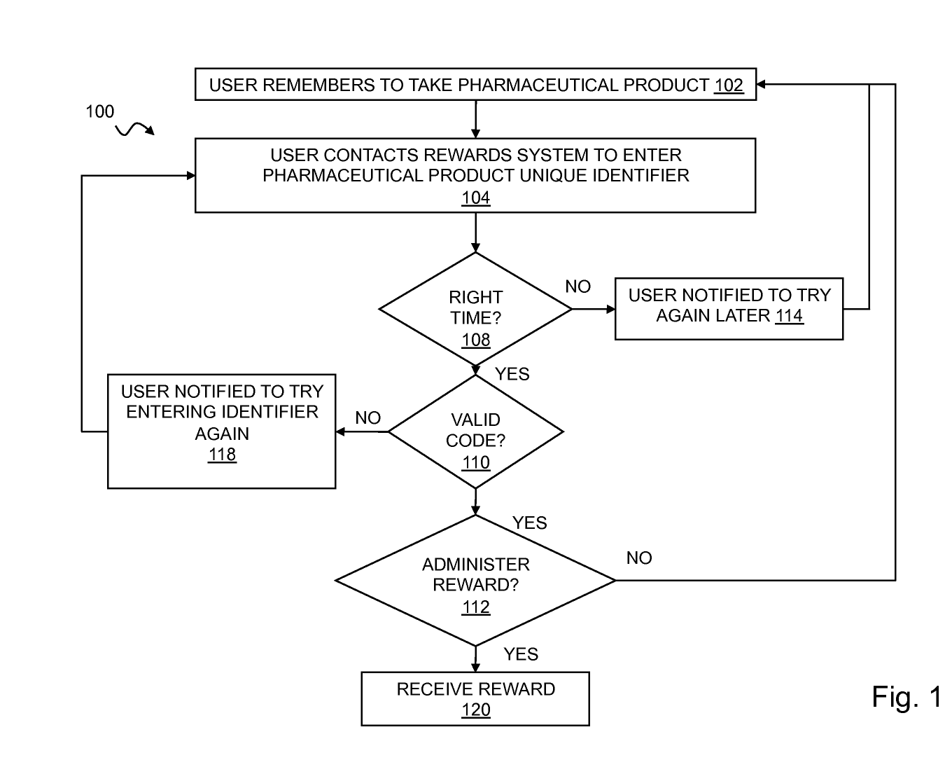

In one embodiment, as shown in the flow chart of FIG. 1, the user may remember to take the pharmaceutical product 102 within a correct time frame 108 such as the predetermined time period noted above and may contact a rewards system to enter a unique identifier 104, along with a user identification as appropriate. If the unique identifier is valid 110 for the user, the system may identify a reward, such as by determining if a reward should be administered 112 to the user for the compliance event. If the unique identifier is not valid, the user may be asked to enter a unique identifier that is valid 118. If the system determines that a reward should be administered, the system may tell the user whether she has obtained a reward 120. Rewards may be provided under various circumstances. For example, the user may receive a reward for each compliance event, or after a predetermined sequence of compliance events that comprise a history of treatment such as an entire course of treatment or some portion thereof. The reward value may vary from each compliance event to the next. If the user does not obtain a reward, she may have another opportunity to contact the rewards system during the time period for a next dose. If the user tries to contact the rewards system at an incorrect time, the user may be instructed to take a medication and contact the center at the next appointed time 114. In an embodiment, the reward system may employ a process for determining when a reward should be administered or of what value the reward should be (or both) 112. For example, the reward frequency or amplitude may be correlated to the recorded frequency of compliance. In an embodiment, when the user accesses the rewards system, a rewards meter may be shown indicating how many compliance events stand between the user and a reward. The value of the reward may be calculated based on the compliance event, the pharmaceutical product, and the like, or the reward may be fixed.

In an en embodiment, the user may be notified when it is time to refill the pharmaceutical product. The system may offer to send a refill request to a pharmacy. In some embodiments, the user must approve the refill request.

In an embodiment, since physicians are deeply concerned about non-compliance, they may choose brands of pharmaceutical product that use the methods and systems described herein to increase their compliance.

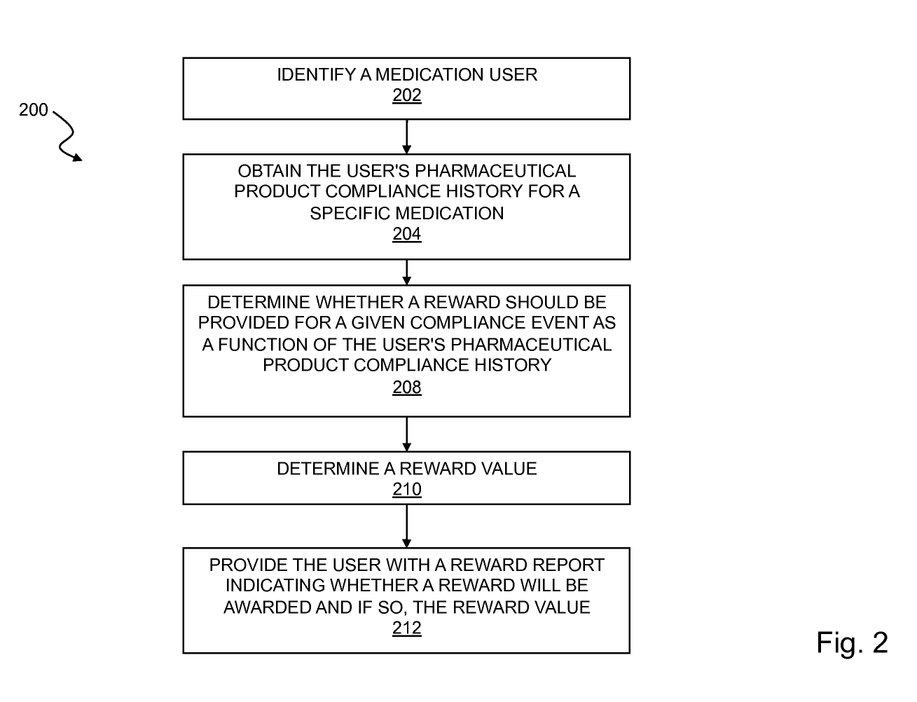

Referring to FIG. 2, a method for improving medication adherence by a user may include identifying a medication user 202, obtaining the user's pharmaceutical product compliance history for a specific medication 204, determining whether a reward should be provided for a given compliance event as a function of the user's pharmaceutical product compliance history 208, if a reward is to be provided, determining a reward value 210, and providing the user with a reward report indicating whether a reward will be awarded and if so, the reward value 212. The method may further comprise calculating a pharmaceutical product compliance rate over a specific period of time based on the pharmaceutical product compliance history and determining whether a reward should be provided for a given compliance event as a function of the user's pharmaceutical product compliance rate. In the method, the reward value may be determined as a function of the user's pharmaceutical product compliance history. In the method, the reward value, the frequency of a reward being awarded, or both may be positively correlated with an improvement in the user's pharmaceutical product compliance history. In the method, the reward value, the frequency of the reward being awarded, or both may be inversely correlated with the user's pharmaceutical product compliance history. In the method, the reward value, the frequency of the reward being awarded, or both may be selected from among a plurality of predetermined values, and wherein each predetermined value is associated with a particular measure of pharmaceutical product compliance.

For example, a user may be prescribed a ten day course of antibiotics. The antibiotics may be dispensed in a blister pack. Each blister may be individually labeled with a unique identifier. When the user is ready to take the medication, he may enter the unique identifier associated with that dose of antibiotic onto a web site for the rewards facility. The system may offer feedback to the user, such as that the dose is early or it is late, that the user should remember to take it with eight ounces of water, the user should stay out of the sun, encouragement for continuing to comply with the prescription, and the like. When the full day course is taken, as evidenced by ten unique identifiers being input to the rewards facility, the user may be rewarded for the complete medication compliance.

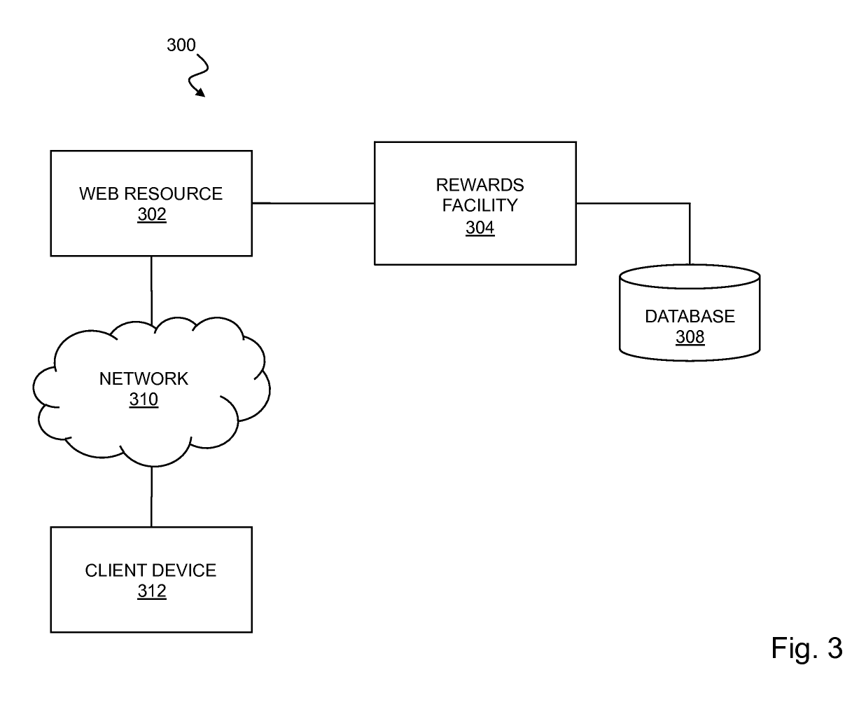

Referring to FIG. 3, a pharmaceutical product compliance reward system may include a web resource 302 for entering a unique identifier from a pharmaceutical product or packaging when a user takes or otherwise utilizes the pharmaceutical product and a reward facility 304 associated with the web resource 302 for identifying a condition for reward based on an identifier entered on the web site.

The web resource 302 may include a user interface such as a web page or the like that provide an input control or field to receive entry of the unique identifier, along with information to identify the user. It will be appreciated that the user interface may receive user identification (such as login credentials) and the unique identifier for the pharmaceutical product sequentially, such as where a user logs in to the web resource 302 and then provides the unique identifier, or the user identification and the unique identifier may be provided together, such as in two data entry fields of a web page. Where the dosage for the pharmaceutical product is independent of the individual being treated, then the user identification may be omitted entirely. More generally, any suitable web page or other network resource (such as a mobile phone resource) may be deployed as the web resource 302 described herein, provided it can operate to receive the appropriate information from a user and present the information to business logic or the like such as the rewards facility 304 described below. In general, the web resource 302 may be deployed on a web server, a file server, or any other suitable hardware and/or software for interacting with a client over a network on one hand, and back end processing on the other hand.

The reward facility 304 may include a processor, or more generally any combination of hardware and or software suitable for receiving compliance events as described above and identifying corresponding rewards, as well as returning the rewards (or related information concerning how to retrieve a reward, or reasons for declining a reward, and so forth) to the user through the web resource 302. In general the reward facility 304 may respond to a user identification and a unique identifier based upon an inference that the pharmaceutical product associated with the unique identifier was used by a user identified by the user identification within some predetermined time period, which may be based upon, e.g., sensitivity of dosage to timing, requirements of a healthcare provider, specifications of the pharmaceutical manufacturer, or any other considerations.

The processor may communicate with a database 308 that stores compliance information and the like. This may include, for example an intended course of treatment relating to the pharmaceutical product, or a history of specific compliance events related to a user that is using the pharmaceutical product. This may also include any useful information relating to the pharmaceutical product (e.g., how to address missed doses, overdoses, and so forth) or information relating to a specific user such as medical history, a specific prescription or history of prescriptions and so forth, along with security measures suitable for the information being stored such as measures mandated by federal regulators, healthcare providers, or the like. The database 308 may also store various reward schemes, schedules, values, and the like. The reward value, the frequency of a reward being awarded, or both may be correlated with the user's medication compliance history. The compliance history may be for a specified period of time.

In operation, a user may operate a client device 312, which may be a mobile device, laptop, cellular phone, personal communication device, desktop computer, and/or any other device suitable for network communications. The user may access the web resource 302 through a network 310 such as the Internet and interact with the web resource 302 to provide compliance information and/or receive rewards.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A pharmaceutical product compliance reward system, comprising:
a web resource for entering a unique identifier from a pharmaceutical product or packaging when a user takes or otherwise utilizes the pharmaceutical product; and
a reward facility associated with the web resource for identifying a condition for reward based on an identifier entered on the web resource.

2. The system of claim 1, wherein the packaging is at least one of a blister pack, a bottle, a carton, an ampoule, a syringe, a pill box, an inhaler, an inhaler cartridge, and a capsule.

3. The system of claim 1, wherein the reward value, the frequency of a reward being awarded, or both are correlated with the user's medication compliance history.

4. The system of claim 3, wherein the compliance history is for a specified period of time.

5. A system comprising:
a web resource adapted to receive a user identification for a user and a unique identifier for a pharmaceutical product over a network from the user; and
a reward facility associated with the web resource, the reward facility configured to identify a reward for the user based on the user identification, the unique identifier and an inference that the user has used the pharmaceutical product within a predetermined time of when the unique identifier is received by the web resource.

6. The system of claim 5, wherein the unique identifier is obtained from packaging for the pharmaceutical product including at least one of a blister pack, a bottle, a carton, an ampoule, a syringe, a pill box, an inhaler, an inhaler cartridge, and a capsule.

7. The system of claim 5 wherein the unique identifier is obtained from the pharmaceutical product.

8. The system of claim 5 wherein the reward is determined based upon a plurality of unique identifiers comprising a treatment history for the user.

9. A method for improving medication adherence by a user, the method comprising:
identifying a medication user;
obtaining the user's pharmaceutical product compliance history for a specific medication;
determining whether a reward should be provided for a given compliance event as a function of the user's pharmaceutical product compliance history;
if a reward is to be provided, determining a reward value; and
providing the user with a reward report indicating whether a reward will be awarded and if so, the reward value.

10. The method of claim 9, further comprising calculating a pharmaceutical product compliance rate over a specific period of time based on the pharmaceutical product compliance history and determining whether a reward should be provided for a given compliance event as a function of the user's pharmaceutical product compliance rate.

11. The method of claim 9, wherein the reward value is determined as a function of the user's pharmaceutical product compliance history.

12. The method of claim 9, wherein the reward value, the frequency of a reward being awarded, or both are positively correlated with an improvement in the user's pharmaceutical product compliance history.

13. The method of claim 9, wherein the reward value, the frequency of the reward being awarded, or both are inversely correlated with the user's pharmaceutical product compliance history.

14. The method of claim 9, wherein the reward value, the frequency of the reward being awarded, or both are selected from among a plurality of predetermined values, and wherein each predetermined value is associated with a particular measure of pharmaceutical product compliance.
